(19) United States
(12) Patent Application Publication
(10) Pub. No.: US 2010/0040522 A1
(43) Pub. Date: Feb. 18, 2010

(54) PROCESS AND APPARATUS FOR THE DRYING OF YELLOWCAKE

(75) Inventor: Glenn Jobling, South Australia (AU)

Correspondence Address: NIXON PEABODY, LLP, 401 9TH STREET, NW, SUITE 900, WASHINGTON, DC, 20004-2128, US

(73) Assignee: ADELAIDE CONTROL ENGINEERS PTY LTD., Thebarton, South Australia (AU)

(21) Appl. No.: 12/527,597

(22) PCT Filed: Feb. 22, 2008
(86) PCT No.: PCT/AU2008/000235

§ 371 Date: Sep. 2, 2009

(30) Foreign Application Priority Data
Feb. 23, 2007 (AU) 2007900945

(51) Int. Cl. C01G 43/00; F26B 17/30

(52) U.S. Cl. 423/3; 34/58

(57) ABSTRACT

A process for the drying of yellowcake, the yellowcake initially being in the form of a low solids content, uranium rich feed slurry, the process including the stages of: a. dewatering the feed slurry to produce a first dewatered solids cake with a solids content higher than the feed slurry; b. re-slurrying the first dewatered solids cake with sufficient water to dissolve at least some impurities and to produce an intermediate slurry with a solids content lower than the first dewatered solids cake; c. dewatering the intermediate slurry to produce a second dewatered solids cake with a solids content higher than the feed slurry; and d. drying the second dewatered solids cake to produce dried yellowcake.

### RELATED APPLICATIONS

This international patent application claims priority from Australian provisional patent application 2007900945, the specification of which is hereby incorporated by reference.

### FIELD OF THE INVENTION

The present invention relates to a process and apparatus for the drying of yellowcake, yellowcake being an intermediate product formed during the processing of uranium bearing ores to produce, for example, uranium peroxide (UO₄.2H₂O) for subsequent conversion or enrichment to form commercial amounts of uranium.

### BACKGROUND OF THE INVENTION

The mining and processing of uranium bearing ores generally always utilizes a leaching process (and thus the use of a lixiviant, such as an aqueous carbonate-bicarbonate solution or an acid solution) to leach the uranium from its accompanying gangue material in the ore body. Such leaching operations may be conducted in conjunction with surface milling operations where the uranium is mined (often in open-pits) and then crushed and blended prior to leaching, or by using in-situ leaching techniques in which the lixiviant is introduced into a subterranean ore deposit and then recovered through suitable extraction systems.

The pregnant lixiviant produced during the leaching process is then processed further to concentrate the uranium therein. This further processing includes a variety of possible chemical treatments, which are usually determined by the characteristics of the specific ore being processed and also its method of extraction. For example, such further processing might include an anionic ion exchange process or solvent extraction. Regardless of the concentration procedure adopted, a relatively concentrated uranium solution is produced, generally called the “eluate”, which must then be treated to precipitate a uranium compound, often referred to simply as “uranium”.

Various precipitation techniques are available, one of which uses (for example) hydrogen peroxide, that are able to precipitate a uranium rich slurry for subsequent washing, dewatering and drying to produce a dry and stable uranium concentrate that can be relatively easily transported. In this respect, the downstream conversion facilities for such uranium concentrates are invariably not located near the sites of the uranium ore bodies, and thus the safe transportation, often over long distances, of the uranium concentrates renders this dry and stable form an ideal intermediate point in the overall uranium production process.

The concentrated uranium produced after precipitation is generally referred to in the art as “yellowcake”. Thus, the uranium rich slurry produced directly from a precipitation process is generally referred to as yellowcake, as is the dry and stable form of the uranium concentrate that exists after the subsequent washing, dewatering and drying processes.

The composition of yellowcake is variable and depends upon the ore body, the lixiviant, the subsequent precipitating conditions, and the subsequent washing, dewatering and drying processes. It consists of a mixture of, amongst other things, several ammonium-uranium-oxygen compounds. Among the compounds most often identified in yellowcakes are sodium diuranate (Na₂U₂O₇), uranium peroxide (UO₄.2H₂O) and ammonium diuranate ((NH₄)₂U₂O₇), along with various uranium oxides such as uranium dioxide (UO₂), uranium trioxide (UO₃), and triuranium octaoxide (U₃O₈).

Modern yellowcake often contains 70 to 90 percent triuranium octaoxide (U₃O₈), and is thus often generically referred to simply as either “uranium oxide” or “U₃O₈”. However, it must be appreciated that a reference to “yellowcake” throughout this patent specification is not to be limited only to one form of yellowcake. Indeed, there is an increasing market for yellowcake that is UO₄.2H₂O based, and this yellowcake is often referred to as the “peroxide” yellowcake. It is this form of yellowcake to which the preferred embodiment described later in this specification relates. For the sake of simplicity and clarity, throughout this patent specification when reference is made to just “yellowcake”, the term is being used to cover all forms and types of yellowcake, with more specific references then being made to “uranium peroxide yellowcake” where necessary.

The price paid for yellowcake by yellowcake conversion facilities is generally dependent upon the yellowcake's purity levels (purity in terms of its concentration of, for example, UO₄.2H₂O). Therefore, producers of uranium peroxide yellowcake generally aim to maximize the concentration of UO₄.2H₂O, which of course requires (amongst other things) the level of impurities in the yellowcake to be minimized, and the moisture content of the yellowcake to be minimized. In terms of moisture content, ideally it will be reduced to less than about 2 wt % for uranium peroxide yellowcake.

Typically, the washing, dewatering and drying processes that have traditionally been adopted to dry yellowcake have been reasonably energy intensive. They have also required large quantities of water which, given the often remote locations of the uranium ore deposits, introduces significant cost issues. These processes generally involve the washing of the precipitation product, which is in the form of a slurry, to remove undesirable chlorides and sulphates, followed by the concentration of the slurry and its drying to minimise the moisture content before it is packaged for sale.

The washing of the precipitation product is accomplished in a number of ways, the most common being to use a clarifier or thickener (often using multiple vessels in series) where the slurry is added to a stirred conical vessel containing mostly water, flocculent is added, and the resulting underflow slurry is withdrawn from the bottom of the vessel. The clear liquour removed from the clarifier is then recycled for further use. Alternatively, the washing function has been accomplished in a centrifuge (again, often using multiple vessels in series), which avoids the need for the addition of flocculent and improves the liquour/product contact for removal of impurities. As with the clarifier/thickener, the end result of centrifuging is a slurry with a high solids concentration (greater than about 50%), which throughout this specification will generally be referred to as a “solids cake”.

The solids cake then requires drying to produce a powdered product suitable for sale for further processing. The drying processes employed generally determine the form of the final product and will normally be chosen on the basis of energy economics for the particular site. There have generally been three alternative dryers used, namely a rotary vacuum dryer, a continuous single screw dryer and a calciner, in ascending order of both energy requirements and capital cost. The former two devices operate at lower temperatures and thus tend to only produce UO₄.2H₂O, while the latter produces U₃O₈ which generally has a higher sale value because of the higher proportion of uranium in a given mass of product (and typically a lower moisture content).

It is an aim of the present invention to provide a process and apparatus for the drying of yellowcake, particularly advantageously for the drying of uranium peroxide yellowcake, which process minimizes both energy and water use, while producing a high uranium content product.

Before turning to a summary of the present invention, it must be appreciated that the above description of the prior art has been provided merely as background to explain the context of the invention. It is not to be taken as an admission that any of the material referred to was published or known, or was a part of the common general knowledge in Australia or elsewhere.

### SUMMARY OF THE INVENTION

The present invention provides a process for the drying of yellowcake, the yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry; and
d. drying the second dewatered solids cake to produce dried yellowcake.

The present invention also provides a process for the drying of uranium peroxide yellowcake, the uranium peroxide yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry; and
d. drying the second dewatered solids cake to produce dried uranium peroxide yellowcake.

In a preferred form, the process of the present invention additionally includes the use of a recycle stage, for the recycle of a portion of the dried yellowcake for mixing with the second dewatered solids cake, to subsequently produce a pre-dryer cake with a solids content higher than the second dewatered solids cake. The pre-dryer cake is then the product that is dried in the final drying stage.

Thus, the present invention further provides a process for the drying of yellowcake, the yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry;
d. mixing the second dewatered solids cake with an amount of recycled, dried yellowcake to produce a pre-dryer cake with a solids content higher than the second dewatered solids cake; and
e. drying the pre-dryer cake to produce dried yellowcake, a portion of which is recycled to the mixing stage.

Further still, the present invention also provides a process for the drying of uranium peroxide yellowcake, the uranium peroxide yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry;
d. mixing the second dewatered solids cake with an amount of recycled, dried uranium peroxide yellowcake to produce a pre-dryer cake with a solids content higher than the second dewatered solids cake; and
e. drying the pre-dryer cake to produce dried uranium peroxide yellowcake, a portion of which is recycled to the mixing stage.

The present invention also provides apparatus for the drying of yellowcake, the yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry; and
d. a dryer for drying the second dewatered solids cake to produce dried yellowcake.

The present invention also provides apparatus for the drying of uranium peroxide yellowcake, the uranium peroxide yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry; and
d. a dryer for drying the second dewatered solids cake to produce dried uranium peroxide yellowcake.

In terms of the additional recycle stage mentioned above, the apparatus of the present invention may additionally include a mixer in order to receive the recycled dried yellowcake and mix it with the second dewatered solids cake.

Thus, the present invention also provides apparatus for the drying of yellowcake, the yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry;
d. a mixer for mixing the second dewatered solids cake with an amount of recycled, dried yellowcake to produce a pre-dryer cake with a solids content higher than the second dewatered solids cake; and
e. a dryer for drying the pre-dryer cake to produce dried yellowcake, a portion of which is recycled to the mixer.

The present invention further provides apparatus for the drying of uranium peroxide yellowcake, the uranium peroxide yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry;
d. a mixer for mixing the second dewatered solids cake with an amount of recycled, dried uranium peroxide yellowcake to produce a pre-dryer cake with a solids content higher than the second dewatered solids cake; and
e. a dryer for drying the pre-dryer cake to produce dried uranium peroxide yellowcake, a portion of which is recycled to the mixer.

Before turning to a more detailed description of the present invention, various terms that will be used need to be further explained. For example, the above statement refers to a “low solids content, uranium rich feed slurry”. The term “low solids content” is used herein to mean a feed slurry having a solids content below about 20% (w/w). Typically, the solids content of the feed slurry will be within a reasonably normal operating range of 2 to 20% (w/w).

Further, the term “uranium rich” is a term used to describe, for example, a concentrated uranium peroxide yellowcake solid produced from a precipitation process (for example, a hydrogen peroxide based precipitation process). The concentrated uranium peroxide yellowcake solid will typically contain in excess of about 80% (w/w) uranium peroxide. With this in mind, it will of course be appreciated that it is the solids component of the “low solids content, uranium rich feed slurry” that is uranium rich.

Further still, by the terms “slurry” and “solids cake” we simply mean the following. A “slurry” is typically a liquid containing suspended solids. Normally, a uranium peroxide slurry, for example, could vary from 1% solids to 40% solids, and still be regarded as a slurry in the traditional sense. A “solids cake” in this specification is the solids discharge typically produced by the centrifuges, which is a high solids content slurry, typically with a solids concentration greater than 40% (w/w), but normally as high as 65 to 75% (w/w).

Finally, the above broad statements of the invention result in the production of a “dried yellowcake” or specifically a, for example, “dried uranium peroxide yellowcake”. The term “dried” in relation to the yellowcake is used herein to mean a yellowcake that has a solids concentration greater than about 95% (w/w). Dried yellowcake, such as dried uranium peroxide (UO₄.2H₂O) yellowcake will typically have a solids concentration of between about 95% (w/w) and 99% (w/w), and has the appearance of a fine yellow powder.

Returning to a general description of the present invention, and with particular reference to the preferred form of the invention that produces a dried uranium peroxide yellowcake, the first dewatering stage is preferably conducted in a centrifuge. The centrifuge preferably separates the solid and liquid phases of the feed slurry according to specific gravity differences and/or particle size. The centrifuge thus produces a centrate (being the liquid phase, which is essentially a water discharge), and a solids cake (being the solid phase, which is essentially the dewatered solids).

The centrate discharged from the centrifuge is preferably directed to a thickener (or settling tank) in order to remove at least some of any remaining solids suspended in solution for return to the process, and also to possibly allow re-use of the liquid phase as wash water in the process. This is envisaged to be possible if the dissolved impurities in the liquid phase are at suitably low levels to permit its re-use, or could be easily processed to get them to low enough levels.

The use of a centrifuge as the preferred type of dewatering means is advantageous for several reasons. Firstly, in traditional processes, the discharge from the chemical treatment plant (as the feed slurry for the process of the present invention) is directed to an apparatus that does not provide much agitation of the liquid, depending instead upon gravity separation to produce a slurry of acceptable concentration. However, a centrifuge of course operates by means of centrifugal force rather than normal gravity force and is therefore able to provide improved separation at higher processing rates. Also, because of the nature of the movement of a slurry within a centrifuge, there is better agitation to promote the dissolving of the water-soluble impurities from the first dewatered solids cake.

Apart from the centrate mentioned above, the first dewatering stage also produces a first dewatered solids cake, which preferably has a solids content in the order of 50% to 70% (w/w), but that is likely to still contain some water-soluble impurities such as chlorides and sulphates which need to be removed.

In the present invention, there is thus then provided a re-slurrying stage that aims to re-slurry the first dewatered solids cake with an amount of water that is sufficient to dilute and/or dissolve at least some of the impurities present (such as the chlorides and sulphates), the extent to which this is required being dependent upon the composition and amount of the impurities initially, and also upon the ultimately required purity levels of the dried yellowcake produced by the process of the invention.

The re-slurrying is ideally conducted in a re-slurry tank. The re-slurry tank is preferably fitted with agitation means, such as a twin paddle agitator, and is able to produce an intermediate slurry containing less than about 20% (w/w) solids, although ideally between about 2% and 20% (w/w) solids. In this respect, the solids content of this intermediate slurry may be at a similar level to the solids content of the feed slurry. However, the intermediate slurry should have reduced impurity levels compared to the feed slurry due to the action of the first dewatering stage, and the re-slurrying, mentioned above.

The re-slurrying (which is often called “re-hydration” or simply “washing”) that occurs in the re-slurry tank is preferably a continuous process with the discharge (the intermediate slurry) being directed to the second dewatering stage mentioned above. In this respect, while it is common for a re-slurrying process to be conducted in line by simply adding water to a flowing stream, this can result in the formation of a slurry of varying strength and can create uneven contact between the re-slurry liquid and the soluble impurities in the stream. By carrying out the re-slurrying in an agitated tank (as is preferred in the present invention), these short-comings are avoided and the extended contact time provides more scope to dissolve the impurities.

Following re-slurry, the intermediate slurry needs to undergo further dewatering to commence the drying process and the movement towards the final, dried uranium peroxide yellowcake. This second dewatering stage is preferably also conducted in a centrifuge, and this second centrifuge preferably operates in a similar manner to the first centrifuge, producing a second centrate and a second dewatered solids cake.

In relation to the second dewatered solids cake produced by the second centrifuge, it is preferably transferred from the second centrifuge to a bi-directional screw conveyor which is capable of being controlled to discharge either back to the re-slurry stage (the re-slurry tank) or to a subsequent mixer. The purpose of this alternative discharge arrangement is to allow the second dewatering stage (the second centrifuge) to remain in operation during temporary shut-downs of either the mixer or the dryer (stages d) and e) mentioned above) or to recycle the solids cake back through re-slurrying and dewatering stages should its impurity content exceed that desired for the process.

The second dewatering stage preferably produces a second dewatered solids cake with a solids content that would normally be in the order of 50% to 70% (w/w) and with levels of impurities (at least in terms of sulphates and chlorides) that are in an acceptable range for the subsequent requirements for the desired uranium peroxide yellowcake.

Where the process of the invention is being used to dry a uranium peroxide yellowcake, this second dewatered solids cake is then advantageously mixed with final dried product in order to commence the final drying stages of the process. In this preferred form, the purpose of the mixer is to provide a product of the required solids content for entry to the dryer. This product will ideally be of uniform consistency, and will ideally be a free-flowing, non-sticky, non-plugging product, typically with a moisture content less than about 12% (w/w). In one form of the present invention, this is achieved by mixing previously-dried product with the second dewatered solids cake to form, in the mixer, a pre-dried cake ready for the final (traditional) drying processes.

In this form, the previously-dried product is preferably extracted from the dryer discharge chute and transferred to the mixer by screw conveyors, while the second dewatered solids cake is delivered to the mixer by the bi-directional conveyor mentioned above to provide a pre-dryer cake. It is envisaged that the preferred recycle ratio of recycled previously-dried product to final dried product will be about 2:1 (or about 200%). However, it will be appreciated that this ratio will depend upon many factors and may be in a wide range of from about 1:1 to about 5:1 (or about 100% to about 500%).

The mixer then preferably discharges this pre-dryer cake, via gravity discharge through a chute, directly into the dryer.

The mixing of the second dewatered solids cake with previously-dried product is an important part of the process of the present invention where the low solids content uranium rich feed slurry is of the uranium peroxide type. The present inventors have determined that ineffective mixing can result in agglomeration of the infeed to the dryer into “balls” which dry only on the outside leaving moisture trapped within the ball. As there are commercial limits to the amount of moisture that can be contained in the final dried uranium peroxide yellowcake, which limits are very difficult to achieve should the mixing result in ball formation, this part of the process of the present invention is particularly beneficial. Indeed, in the preferred form, where the mixer is a twin-screw mixer, the propensity for ball formation is even further minimised because of the continuous shearing action on the mix.

In a preferred form, the dryer of the final stage of the process of the present invention is preferably an indirect dryer (a conduction or contact dryer), such as a rotating screw dryer that operates continuously or semi-continuously. In a preferred form, the rotating screw dryer will utilise continuous flights, and will be either a twin-screw or quad-screw dryer. Preferably, the flights will be hollow flights heated by the passage therethrough of a heat transfer medium such as water, steam or thermal oil.

In the production of dried uranium peroxide yellowcake by means of traditional dryers, such as externally-heated dryers, the dryer is normally of the “porcupine” type. Such dryers often consist of a rotor with heated paddles arranged in a screw format which act in a similar manner to a single screw conveyor and transfer the material from an infeed end to an outfeed end during the drying process. However, such dryers have the inherent disadvantages of single screw conveyors and may, under unfavourable circumstances, cease to transfer product but merely have it rotate with the rotor. The use in the present invention of the preferred form of twin-screw or quad-screw dryer with continuous flights is expected to overcome this transfer problem and provide for better contact between the product and the heating surfaces.

Dried product from the dryer preferably discharges by gravity into a storage hopper incorporating any known type of drum filling and weighing system from which the dried yellowcake is packaged for sale. As mentioned above, the composition and moisture content of the dried yellowcake will typically be dependent upon the composition of the feed slurry used in the process, which in turn will be dictated by the composition of the original uranium bearing ores and also that nature of the processing steps adopted to produce the feed slurry. However, in general terms, it is expected that dried yellowcake produced by the present invention will be a free-flowing yellowcake powder with a moisture content in the order of 2% to 5% (w/w).

### BRIEF DESCRIPTION OF THE DRAWINGS

Having briefly described the general concepts involved with the present invention, a preferred embodiment will now be described that is in accordance with the present invention. However, it is to be understood that the following description is not to limit the generality of the above description.

In the drawings:

FIG. 1 is a schematic flow diagram showing a process for the drying of uranium peroxide yellowcake in accordance with a first preferred embodiment of the present invention; and

FIG. 2 is a schematic flow diagram showing a process for packaging dried uranium peroxide yellowcake produced by the process shown in FIG. 1.

### DESCRIPTION OF A PREFERRED EMBODIMENT

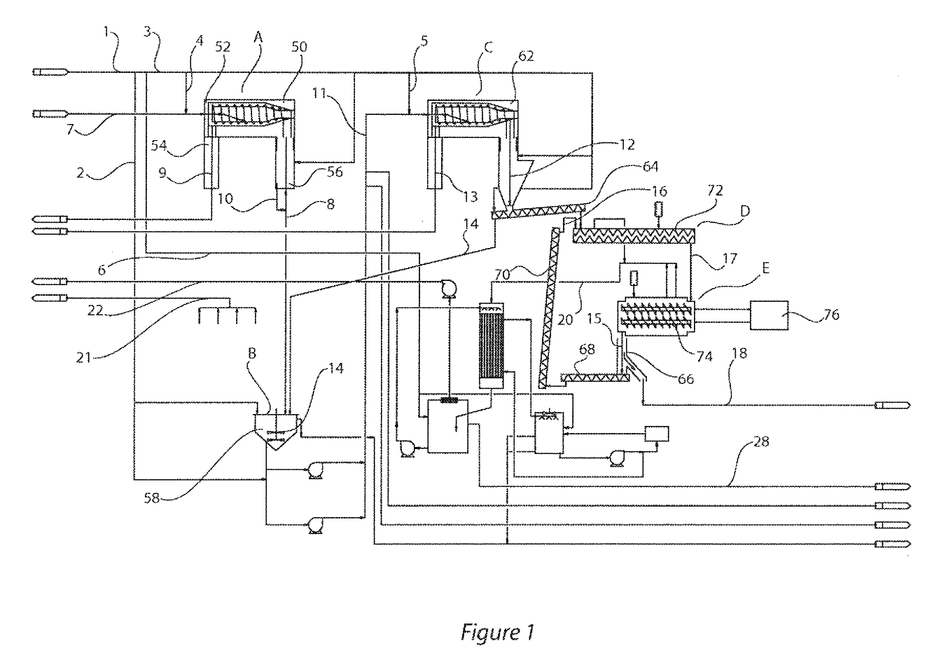

FIG. 1 provides a flow diagram of a preferred embodiment of the process of the present invention, being one that is a process for the drying of uranium peroxide yellowcake. The main product flow path has been bolded to distinguish it from ancillary flow paths (such as the paths that show the movement of water, off-gases, centrate, and the like) as will be explained later.

The main product flow path shows a low solids content, uranium rich feed slurry 7 of the uranium peroxide type being fed to a first dewatering means A for dewatering to produce a first dewatered solids cake 8 with a solids content higher than the feed slurry 7. In one form, it is envisaged that the feed slurry will have the following approximate composition:

Feed Slurry - Typical Composition

| | |
|---|---|
| Solids % | 2 to 20% (w/w) |
| UO₄•2H₂O Concentration | 70 to 90% of solids |
| Specific Gravity | 1.05 to 1.1 |
| Sulphates | 5 to 20 g/L |
| Chlorides | 1,000 to 30,000 ppm |
| pH | 5 to 6.5 |

The first dewatering means A is preferably a centrifuge 50 that separates the solid and liquid phases of the feed slurry 7 according to specific gravity differences and/or particle size. The centrifuge 50 thus produces a centrate 9 (being the liquid phase, which is essentially a water discharge), and the first dewatered solids cake 8 (being the solid phase, which is essentially the dewatered solids).

The centrifuge 50 consists of a fixed base or casing which carries a rotating element and its drive motor, the details of which are not illustrated in the flow diagram of FIG. 1. The rotating element (or rotor) is preferably made up of a cylindrical section (or bowl) where the liquid is clarified and a conical section (or beach) from where the solids are conveyed out of the liquid by, for example, a screw conveyor (a scroll) inserted into the cylindrical section through an open end of the conical section. Centrifuges of this type are sometimes referred to as decanter centrifuges, solid bowl centrifuges or scroll centrifuges.

The feed slurry 7 is preferably introduced at an infeed end 52 of the rotating element through a stationary feed tube. The centrifugal force caused by the rotation of the cylindrical section of the centrifuge 50 results in the formation of a continuous solid layer over the inside surface thereof. As will be appreciated, because of the centrifugal forces created by the rotation, the heavier particles will move towards the wall of the cylindrical section, leaving the lighter solids and liquid in a liquid phase (the centrate) in the inner section of the rotating layer. The heavier particles form the first dewatered solids cake 8 mentioned above and are preferably then transferred by the screw conveyor, from the cylindrical section via the conical section, which forms a barrier to the transfer of the liquids, to a solids discharge port.

The centrate 9 preferably flows in the same direction as the first dewatered solids cake 8 and returns to the liquid feed end of the cylindrical section of the rotating element of the centrifuge 50 via return tubes, to where it discharges over adjustable weir plates. The centrate and the first dewatered solids cake can then be collected in separate compartments of the casing of the centrifuge, from which they fall by gravity into their respective discharge chutes 54,56. In one form, it is envisaged that the first dewatered solids cake will have the following approximate composition:

First Dewatered Solids Cake - Typical Composition

| | |
|---|---|
| Solids % | 50 to 70% (w/w) |
| UO₄•2H₂O Concentration | 70 to 90% of solids |
| Specific Gravity | 2.1 to 2.4 |
| Sulphates | 1 to 5 g/L |
| Chlorides | 500 to 7,500 ppm |
| pH | 6 to 6.5 |

The centrate 9 discharged from the centrifuge 50 is preferably directed to a thickener (not shown) to further separate any remaining solids in the centrate 9 from the liquid phase. These remaining solids can be returned to the process, or can be disposed of, depending on their uranium content. The liquid phase may be able to be reused as process water, depending upon its impurity levels. For example, often this liquid phase will have high chloride and/or sulphate levels and thus will not be reusable in this manner.

The first dewatered solids cake 8 is then fed to a re-slurry means B for re-slurrying with sufficient water 2 to dilute and/or dissolve at least some impurities and to produce an intermediate slurry 11 with a solids content lower than the first dewatered solids cake 8. The re-slurrying is conducted in a re-slurry (or repulp) tank 58 where the first dewatered solids cake 8 discharged from the first centrifuge 50 is mixed with sufficient water 2 to dissolve a majority of the water soluble impurities such as the chlorides and sulphates. The re-slurry tank 58 is fitted with agitation means, such as a twin paddle agitator 60, which ideally operates continuously to produce the intermediate slurry 11.

The actual composition of the intermediate slurry is dependent upon, amongst other things, how much water is added, and it should be somewhat similar to the typical composition referred to above of the feed slurry.

The intermediate slurry 11 is then fed to the second dewatering means C for dewatering to produce a second dewatered solids cake 12 with levels of impurities (at least in terms of sulphates and chlorides) that are in an acceptable range for the subsequent requirements for the desired yellowcake. The second dewatering means C is also a centrifuge (the second centrifuge 62) and is ideally of the same configuration (and operation) as described above for the first centrifuge 50. As before, the second centrate 13 discharged from this second centrifuge 62 may also be directed to a thickener (not shown) for the same purpose as described above. In one form, it is envisaged that the second dewatered solids cake will have the following approximate composition:

Second Dewatered Solids Cake - Typical Composition

| | |
|---|---|
| Solids % | 50 to 70% (w/w) |
| UO₄•2H₂O Concentration | 70 to 90% of solids |
| Specific Gravity | 2.1 to 2.4 |
| Sulphates | 0.5 to 1.0 g/L |
| Chlorides | 250 to 2,000 ppm |
| pH | 6 to 6.5 |

The second dewatered solids cake 12 is dried further prior to its entry to the dryer E, this pre-drying being effected by mixing the second dewatered solids cake 12 with an amount of previously dried, recycled, product 16 in a pre-determined ratio. The second dewatered solids cake 12 is thus mixed in the mixer D with previously dried uranium peroxide yellowcake 16 to produce a pre-dryer cake 17 with a solids content higher than the second dewatered solids cake 12.

To effect this mixing, the second dewatered solids cake 12 is transferred from the second centrifuge 62 to a bi-directional screw conveyor 64, for transfer to the mixer D. Previously-dried product 16 is extracted from the dried uranium peroxide yellowcake product 15 exiting the dryer discharge chute 66 and is transferred (as a recycle) to the mixer D by screw conveyors 68,70.

As mentioned above, it is envisaged that the preferred recycle ratio of recycled previously-dried product 16 to final dried product 18 will be about 2:1 (or about 200%). However, it will be appreciated that this ratio will depend upon many factors and may be in a wide range of from about 1:1 to about 5:1 (or about 100% to about 500%).

The mixer D is a twin-screw paddle mixer 72 suitable for handling “sticky” product and is of sufficient length to ensure adequate mixing of the second dewatered solids cake 12 and the previously-dried product 16 to form the pre-dryer cake 17. The mixer 72 then discharges this pre-dryer cake 17, via gravity discharge through a chute, directly into the dryer E. In one form, it is envisaged that the pre-dryer cake will have the following approximate composition:

Pre-Dryer Cake - Typical Composition

| | |
|---|---|
| Solids % | 80 to 90% (w/w) |
| UO₄•2H₂O Concentration | 70 to 90% of solids |
| Specific Gravity | 3.0 to 3.5 |
| Sulphates | 0.65 to 1.3 g/L |
| Chlorides | 325 to 2,600 ppm |

Before turning to a more specific description of the dryer E, the bi-directional screw conveyor 64 requires further description. As briefly mentioned above, the bi-directional screw conveyor 64 is able to transfer the second dewatered solids cake 12 to the mixer D, but it is also capable of being controlled to discharge second dewatered solids cake 12 back to the re-slurry tank 58 via stream 14. This arrangement allows the second centrifuge 62 to remain in operation during temporary shut-downs of either the mixer D or the dryer E, or to recycle the second dewatered solids cake 12 back through the re-slurrying and dewatering stages (B and C) should its impurity content exceed that desired for the process.

In relation to the operation of the preferred type of dryer off-gas system, the pre-dryer cake 17 enters the dryer E at an approximate solids concentration of about 88%. The cake is heated up in the dryer to evaporate the remaining water (both free water and some bound water), and the evaporated water is drawn out of the dryer using an induced draught fan.

The saturated water vapour that is thus removed from the dryer E is called the off-gas, and it leaves the dryer at approximately 100 to 120° C. It is then passed through a shell and tube heat exchanger in order to cool the off-gas to approximately 40° C. Water from a cooling tower is used as the cooling medium in the heat exchanger. As the off-gas cools, the saturated water vapour condenses in the vapour tank. This water, as well as any entrained uranium, is collected at this point. The overflow from the vapour tank is sent back to the thickener to recover any uranium carryover, and the cooled off-gas can now be passed through a baghouse filter (and then a secondary filter) before being exhausted to atmosphere via a stack.

Returning to a description of the dryer E, the pre-dryer cake 17 produced by the mixer D is of course dried in the dryer E to produce dried uranium peroxide yellowcake 15, a portion of which becomes the recycled, dried uranium peroxide yellowcake 16 for recycle to the mixer D (as mentioned above), with the balance becoming the final dried uranium peroxide yellowcake product 18. The dryer E is ideally an indirect dryer such as a rotating screw dryer 74. Although not clearly shown in the flow diagram, the rotating screw dryer 74 ideally utilises continuous flights, and will be either a twin or quad screw dryer. Preferably, the flights will be hollow flights heated by the passage therethrough of a heat transfer medium such as water, steam or thermal oil 76.

Dried Uranium Peroxide Yellowcake - Typical Composition

| | |
|---|---|
| Solids % | 95 to 98% (w/w) |
| UO₄•2H₂O Concentration | 70 to 90% of solids |
| Specific Gravity | 4 to 4.5 |
| Sulphates | 0.7 to 1.5 g/L |
| Chlorides | 360 to 3,000 ppm |

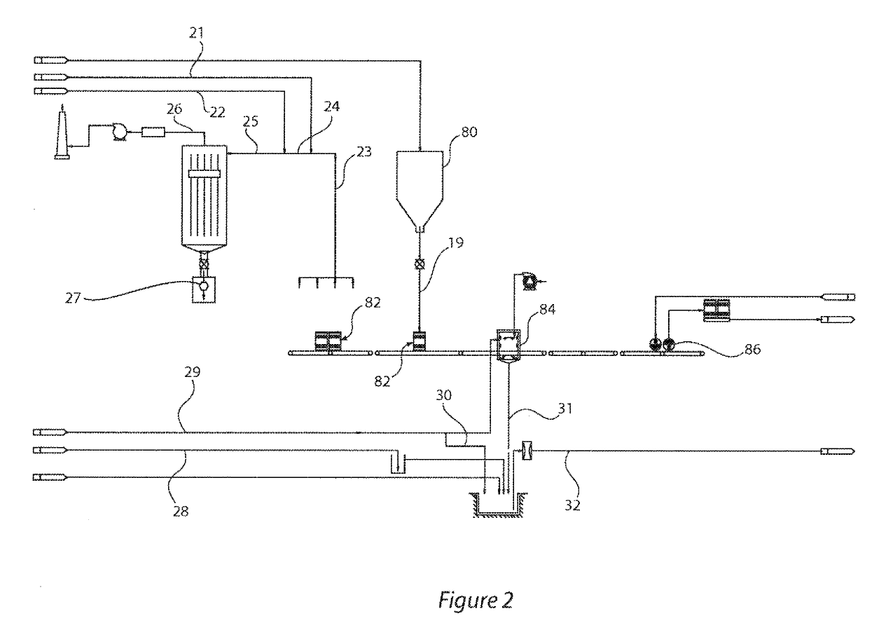

Referring now to FIG. 2, the final dried uranium peroxide yellowcake product 18 from the dryer 74 preferably discharges by gravity into a storage hopper 80 incorporating any known type of drum filling and weighing system from which the dried uranium peroxide yellowcake is packaged into drums 82 for subsequent drum washing and drying in a wash system 84, before transfer to the transport loading station 86.

In conclusion, it must be appreciated that there may be other variations and modifications to the configurations described herein which are also within the scope of the present invention.

1-72. (canceled)

73. A process for the drying of yellowcake, the yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry; and
d. drying the second dewatered solids cake to produce dried yellowcake.

74. A process according to claim 73, wherein the feed slurry has a solids content below about 20% (w/w).

75. A process according to claim 73, wherein the first dewatering stage is conducted in a first centrifuge, the first centrifuge producing a first centrate and the first dewatered solids cake.

76. A process according to claim 75, wherein the first centrate is transferred to a thickener to separate solids in the first centrate from its liquid phase.

77. A process according to claim 73, wherein the first dewatered solids cake has a solids content in the range of 50% to 70% (w/w).

78. A process according to claim 73, wherein the re-slurrying is conducted in a re-slurry tank where the first dewatered solids cake is mixed with sufficient water to dissolve a majority of any water soluble impurities therein.

79. A process according to claim 78, wherein the re-slurry tank is fitted with agitation means.

80. A process according to claim 79, wherein the agitation means is a twin paddle agitator.

81. A process according to claim 73, wherein the intermediate slurry has a solids content below about 5% (w/w).

82. A process according to claim 73, wherein the second dewatering stage is conducted in a second centrifuge, the second centrifuge producing a second centrate and the second dewatered solids cake.

83. A process according to claim 82, wherein the second centrate is transferred to a thickener to further separate any remaining solids in the second centrate from its liquid phase.

84. A process according to claim 83, wherein the second dewatered solids cake has a solids content in the range of 50% to 70% (w/w).

85. A process according to claim 73, wherein a portion of the second dewatered solids cake can be recycled back to the re-slurrying stage.

86. A process according to claim 85, wherein the recycle is effected by transferring the second dewatered solids cake to a bi-directional screw conveyor which is capable of being controlled to discharge to the re-slurrying stage.

87. A process according to claim 73, wherein the drying is conducted in an indirect dryer.

88. A process according to claim 87, wherein the indirect dryer is a rotating screw dryer that operates continuously or semi-continuously.

89. A process according to claim 88, wherein the rotating screw dryer utilises continuous flights.

90. A process according to claim 89, wherein the flights are hollow flights heated by the passage therethrough of a heat transfer medium such as water, steam or thermal oil.

91. A process according to claim 88, wherein the rotating screw dryer is either a twin-screw or quad-screw dryer.

92. A process according to claim 73, wherein the yellowcake is uranium peroxide yellowcake.

93. A process for the drying of yellowcake, the yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry;
d. mixing the second dewatered solids cake with an amount of recycled, dried yellowcake to produce a pre-dryer cake with a solids content higher than the second dewatered solids cake; and
e. drying the pre-dryer cake to produce dried yellowcake, a portion of which is recycled to the mixing stage.

94. A process according to claim 93, wherein the ratio of dried yellowcake recycled from the drying stage and mixed with the second dewatered solids cake in the mixing stage is in the range of about 1:1 to 5:1 (recycled previously-dried product to final dried product).

95. A process according to claim 94, wherein the ratio is about 2:1.

96. A process according to claim 93, wherein the mixing is conducted in a twin-screw paddle mixer.

97. A process according to claim 96, wherein the paddle mixer forms a pre-dryer cake that has a moisture content less than about 12% (w/w).

98. A process according to claim 93, wherein a portion of the second dewatered solids cake can be recycled back to the re-slurrying stage.

99. A process according to claim 98, wherein the recycle is effected by transferring the second dewatered solids cake to a bi-directional screw conveyor which is capable of being controlled to discharge to the re-slurrying stage.

100. A process according to claim 93, wherein the drying is conducted in an indirect dryer.

101. A process according to claim 100, wherein the indirect dryer is a rotating screw dryer that operates continuously or semi-continuously.

102. A process according to claim 101, wherein the rotating screw dryer utilises continuous flights.

103. A process according to claim 102, wherein the flights are hollow flights heated by the passage therethrough of a heat transfer medium such as water, steam or thermal oil.

104. A process according to claim 101, wherein the rotating screw dryer is either a twin-screw or quad-screw dryer.

105. A process according to claim 93, wherein the yellowcake is uranium peroxide yellowcake

106. A process for the drying of uranium peroxide yellowcake, the uranium peroxide yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry; and
d. drying the second dewatered solids cake to produce dried uranium peroxide yellowcake.

107. A process for the drying of uranium peroxide yellowcake, the uranium peroxide yellowcake initially being in the form of a low solids content, uranium rich feed slurry, the process including the stages of:
a. dewatering the feed slurry to produce a first dewatered solids cake with a solids content higher than the feed slurry;
b. re-slurrying the first dewatered solids cake with sufficient water to dissolve at least some impurities and to produce an intermediate slurry with a solids content lower than the first dewatered solids cake;
c. dewatering the intermediate slurry to produce a second dewatered solids cake with a solids content higher than the feed slurry;
d. mixing the second dewatered solids cake with an amount of recycled, dried uranium peroxide yellowcake to produce a pre-dryer cake with a solids content higher than the second dewatered solids cake; and
e. drying the pre-dryer cake to produce dried uranium peroxide yellowcake, a portion of which is recycled to the mixing stage.

108. Apparatus for the drying of yellowcake, the yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry; and
d. a dryer for drying the pre-dryer cake to produce dried yellowcake.

109. Apparatus according to claim 108, wherein the first dewatering means is a first centrifuge, the first centrifuge producing a first centrate and the first dewatered solids cake.

110. Apparatus according to claim 109, including a thickener for separating solids in the first centrate from its liquid phase.

111. Apparatus according to claim 108, wherein the re-slurrying means is a re-slurry tank where the first dewatered solids cake is mixed with sufficient water to dissolve a majority of any water soluble impurities therein.

112. Apparatus according to claim 111, wherein the re-slurry tank is fitted with agitation means.

113. Apparatus according to claim 112, wherein the agitation means is a twin paddle agitator.

114. Apparatus according to claim 108, wherein the second dewatering means is a second centrifuge, the second centrifuge producing a second centrate and the second dewatered solids cake.

115. Apparatus according to claim 114, including a thickener for separating solids in the second centrate from its liquid phase.

116. Apparatus according to claim 108, wherein a portion of the second dewatered solids cake can be recycled back to the re-slurrying means, and the recycle is effected by transferring the second dewatered solids cake to a bi-directional screw conveyor which is capable of being controlled to discharge to the re-slurrying means.

117. Apparatus according to claim 108, wherein the dryer is an indirect dryer.

118. Apparatus according to claim 117, wherein the indirect dryer is a rotating screw dryer that operates continuously or semi-continuously.

119. Apparatus according to claim 118, wherein the rotating screw dryer utilises continuous flights.

120. Apparatus according to claim 119, wherein the flights are hollow flights heated by the passage therethrough of a heat transfer medium such as water, steam or thermal oil.

121. Apparatus according to claim 118, wherein the rotating screw dryer is either a twin-screw or quad-screw dryer.

122. Apparatus according to claim 108, wherein the yellowcake is uranium peroxide yellowcake.

123. Apparatus for the drying of yellowcake, the yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry;
d. a mixer for mixing the second dewatered solids cake with an amount of recycled, dried yellowcake to produce a pre-dryer cake with a solids content higher than the second dewatered solids cake; and
e. a dryer for drying the pre-dryer cake to produce dried yellowcake, a portion of which is recycled to the mixing stage.

124. Apparatus according to claim 123, wherein the ratio of dried yellowcake recycled from the dryer and mixed with the second dewatered solids cake in the mixer is in the range of about 1:1 to 5:1 (recycled previously-dried product to final dried product).

125. Apparatus according to claim 124, wherein the ratio is about 2:1.

126. Apparatus according to claim 123, wherein the mixer is a twin-screw paddle mixer.

127. Apparatus according to claim 123, wherein a portion of the second dewatered solids cake can be recycled back to the re-slurrying stage.

128. Apparatus according to claim 127, wherein the recycle is effected by transferring the second dewatered solids cake to a bi-directional screw conveyor which is capable of being controlled to discharge to the re-slurrying stage.

129. Apparatus according to claim 123, wherein the dryer is an indirect dryer.

130. Apparatus according to claim 129, wherein the indirect dryer is a rotating screw dryer that operates continuously or semi-continuously.

131. Apparatus according to claim 130, wherein the rotating screw dryer utilises continuous flights.

132. Apparatus according to claim 131, wherein the flights are hollow flights heated by the passage therethrough of a heat transfer medium such as water, steam or thermal oil.

133. Apparatus according to claim 130, wherein the rotating screw dryer is either a twin-screw or quad-screw dryer.

134. Apparatus according to claim 123, wherein the yellowcake is uranium peroxide yellowcake.

135. Apparatus for the drying of uranium peroxide yellowcake, the uranium peroxide yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry; and
d. a dryer for drying the pre-dryer cake to produce dried uranium peroxide yellowcake.

136. Apparatus for the drying of uranium peroxide yellowcake, the uranium peroxide yellowcake initially being in the form of a low solids content, uranium rich feed slurry, the apparatus including:
a. a first dewatering means for dewatering the feed slurry to produce a first dewatered solids cake with a solids content higher than the feed slurry;
b. a re-slurrying means for re-slurrying the first dewatered solids cake with sufficient water to dissolve at least some impurities and to produce an intermediate slurry with a solids content lower than the first dewatered solids cake;
c. a second dewatering means for dewatering the intermediate slurry to produce a second dewatered solids cake with a solids content higher than the feed slurry;
d. a mixer for mixing the second dewatered solids cake with an amount of recycled, dried uranium peroxide yellowcake to produce a pre-dryer cake with a solids content higher than the second dewatered solids cake; and
e. a dryer for drying the pre-dryer cake to produce dried uranium peroxide yellowcake, a portion of which is recycled to the mixing stage.
